(19) United States
(12) Patent Application Publication
(10) Pub. No.: US 2007/0169116 A1
(43) Pub. Date: Jul. 19, 2007

(54) Method and system for automated installation of system specific drivers

(75) Inventors: Manoj Sharad Gujarathi, Round Rock, TX (US); Charles T. Perusse JR., Pflugerville, TX (US); Brent Schroeder, Austin, TX (US); Weijia Zhang, Round Rock, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/333,938

(22) Filed: Jan. 18, 2006

(51) Int. Cl. G06F 9/445

(52) U.S. Cl. 717/174

(57) ABSTRACT

A system and method for automatically installing system-specific drivers in a pre-operating system environment include the utilization of a driver locator. The driver locator is stored within nonvolatile memory and allows the target system to access the driver locator in a pre-operating system environment. The driver locator includes system-specific identification information and directs the system to an operating system installation resource in a pre-operating system environment. The operating system installation resource is further operable to identify at least one driver needed for the target system based on information incorporated with the driver locator.

### TECHNICAL FIELD

The present invention is related to the field of computer systems and more specifically to a method and system for the automated installation of drivers.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One of the challenges facing small businesses and large information technology organizations alike during the provisioning of operating systems on their information handling systems (which may be referred to generally as computer systems herein) is making sure that the correct set of drivers needed for each system is properly provided. Finding and installing a correct set of drivers remains a significant challenge to operating system deployment. Typically a post-operating system, network based update is utilized to determine whether each computer system has all necessary driver and to provide such drivers to the computer system.

Additionally, various hardware vendors offer solutions in the form of hardware specific media such as compact disks that carry the needed drivers and tools for a given hardware component. These media are typically provided to customers along with the system hardware. Providing the needed drivers and tools in this manner is problematic for a number of reasons. First, a manual driver installation process is a multi-step endeavor requiring the proper identification of vendor supplied media as well as the requisite time and expertise necessary to properly install the operating system and the necessary drivers. Additionally, these applications often utilize a bootable kernel environment which can cause unnecessary file system conversions as well as stability and compatibility issues and may load unneeded drivers onto the system.

The current methodology is cost ineffective and results in an often unmarshalled and manual process of operating system installation, often leading to installation blockages and errors. Such errors and installation often require valuable information technology resources, including support center time and expertise, to resolve.

### SUMMARY OF THE INVENTION

Therefore a need has arisen for a system and method for the automated installation of hardware specific drivers.

A further need has arisen for a system and method for installing drivers specific to a target system in a pre-operating system installation environment.

The present disclosure describes a system and method for automatically installing system-specific in a pre-operating system environment, utilizing a driver locator, that reduces or eliminates problems associated with post-operating system driver installation.

In one aspect an information handling system is disclosed that includes a target system that has a nonvolatile memory. A driver locator is stored within nonvolatile memory and allows the target system to access the driver locator in a pre-operating system environment. The information handling system also includes an operating system installation resource that is in communication with the target system, where the driver locator is operable to facilitate the connection of the target system with the operating system installation resource in a pre-operating system environment. The operating system installation resource is further operable to identify at least one driver needed for the target system based on the driver locator.

In another aspect, a driver located for use in a pre-operating system environment data operable to direct an associated target system to an appropriate operating system installation resource in a pre-operating system environment. The driver locator comprises a universal resource locator.

In yet another aspect, a method for automatically installing drivers in a pre-operating system environment is described. The method includes providing a driver locator within a nonvolatile memory of a target system and accessing the driver located in a pre-operating system environment. The method also includes accessing an operating system installation resource using the driver locator and determining, by the operating system installation resource, at least one driver based on information incorporated within the driver locator.

The present disclosure includes a number of important technical advantages. One important technical advantage is the use of a driver locator stored in the nonvolatile memory and accessible in a pre-operating system environment. Additionally, the driver locator allows a target system to locate and install target system-specific drivers based on the information contained within the driver locator. Additional advantages will be apparent to those of skill in the art from the figures description claims provided herein.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 shows a diagram of an information handling system in accordance with the teachings of the present disclosure;

FIG. 2 shows a flow diagram showing a method for automatically installing drivers in a pre-operating system environment according to teachings of the present disclosure; and

FIG. 3 shows a flow diagram showing a method according to teachings of the present disclosure.

### DETAILED DESCRIPTION OF THE INVENTION

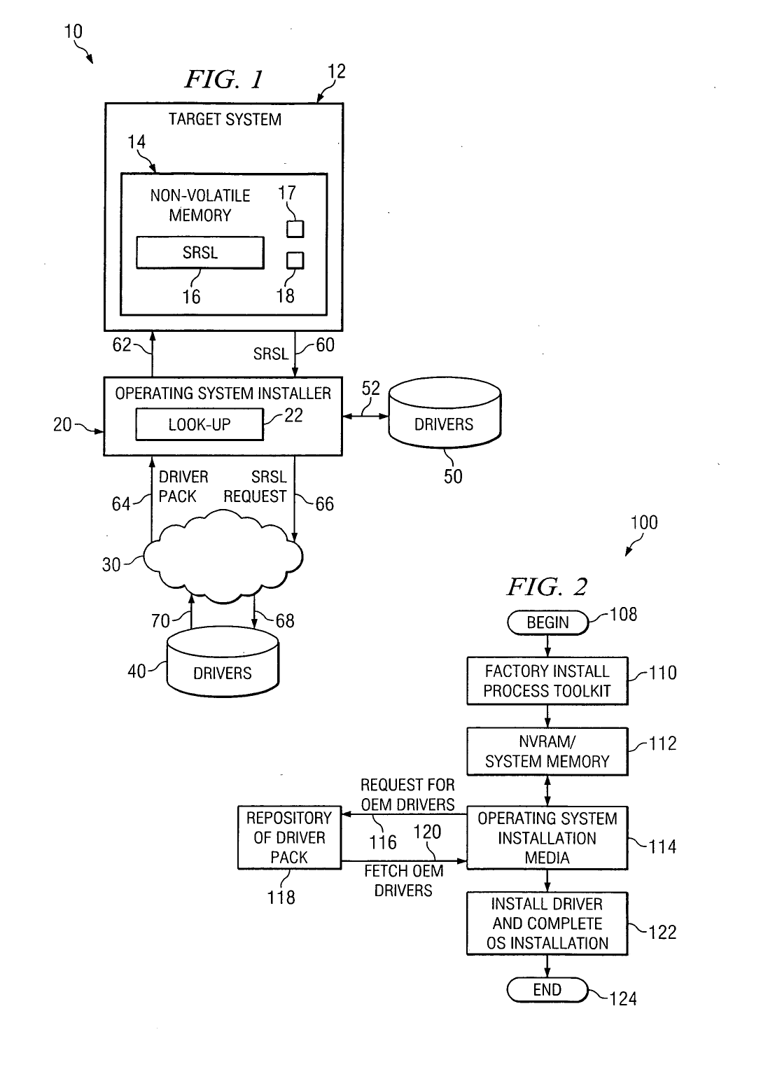

Preferred embodiments of the invention and its advantages are best understood by reference to FIGS. 1-3 wherein like numbers refer to like and corresponding parts and like element names to like and corresponding elements.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Now referring to FIG. 1, an information handling system, referred to generally at 10, is shown. Information handling system 10 includes target system 12, operating system installer 20 and driver databases 40 and 50. Target system 12 includes nonvolatile memory 14 and driver locator 16 stored thereon. Target system 12 is a computer system that includes suitable processing and memory resources well known to those of skill in the art, but does not yet have an intended operating system installed thereon. Driver locator 16 may also be referred to as a system resource and support locator (SRSL). Target system 12 may access driver locator 12 in a pre-operating system environment and utilize driver locator 16 to communicate and access operating system installer 20. A pre-operating system environment may also be referred to as a pre-installation and may preferably provide a framework to deploy various system tools, prior to the installation of the intended operating system. The term “post-operating system” may also be used herein and generally refers to operations occurring after the installation of the operating system onto information handling system 10.

In one embodiment driver locator 16 may comprise a network address. In a particular embodiment the network address is a universal resource locator (URL). In one particular embodiment, the driver locator comprises a URL which incorporates a system type identifier (or platform ID) that corresponds with the system type (or platform ID) of the target system. Example system types may includes system models such as, for instance, a Dell PE1400 or PE2800 or any other suitable system type identifier. In another example embodiment, Driver locator may incorporate a service tag associated with target system within the URL address. In another embodiment the driver locator 16 may include an identifier that is able to uniquely identify the target system.

In alternate embodiments driver locator 16 may incorporate a selected support site location therein. For example, the URL may incorporate a support site associated with a particular original equipment manufacturer. Driver locator 16 may be provided as a complete URL or may be constructed using data (such as data block 17 and 18) stored within nonvolatile memory 14. For instance, data block 17 may contain a unique identifier such as a service tag associated with target system 12 and data block 18 may contain a code denoting a system type identifying the system type of target system 12.

Accordingly, driver locator 16 can be constructed by incorporating information contained within nonvolatile memory 14 such as data blocks 17 and 18. For instance, driver locator 16 may include a generic address (such as an address of a support site associated with a hardware or software manufacturer) originally provided in the driver locator 16 (or provided in a separate data block) combined with target system specific information such as that stored in data blocks 17 and 18. In this manner, driver locator 16 may be provided either as a complete address or may be constructed using data stored within nonvolatile memory 14.

For example, operating system installer utility 20 may begin installation of the OS by constructing a driver locator 16 from a generic URL and system specific information such as system type (platform ID) and service tag (or other suitable unique identifier). As discussed herein, the term service tag includes any unique identifier assigned by a manufacturer, user or other entity to uniquely identify a particular information handling system or component. Operating system installer may then query lookup table 22 to determine the required drivers or software stack. An example driver locator that includes a generic support URL, system ID data and service tag data is listed below: http://www.dell.com/GetDriverPack.class?SystemID=Pe1800&S erviceTag=PECEFID

The operating system installer 20 includes lookup table 22. Lookup table 22 includes a listing of multiple target systems (or system types) and the drivers required for each target system (or system type). Operating system installer 20 is connected to target system 12 by a network or other suitable connection.

Driver databases 40 and 50 each store various drivers which may be required to be loaded onto various target systems such as target system 12. Operating system installer 20 (which may also be referred to as operating system installation resource 20) is in operable communication with driver databases 40 and 50. In the present embodiment, operating system installer 20 is in communication with driver database 50 through direct or local link 52. Operating system installer 20 is in operable communication with driver database 40 via network 30. Network 30 may be any suitable public or private network.

Driver databases 40 and 50 may be populated with necessary drivers and other applications that may be required, by a hardware manufacturer, the OS provider, or a user and may be made available by a public or private network that is accessible to OS software installer 20. The software on databases 40 and 50 may be in a standard or an open format described by a meta-file with information such as package content supported systems and execution methods. Further, databases 40 and 50 may contain structured packages of drivers for each supported system type. These structured packages could be further componentized for mass storage device and network drivers and may preferably satisfy OS requirements for certification.

In operation, target system 12 may access driver locator 16 stored within the nonvolatile memory of 14 in a pre-operating system environment. If driver locator 12 contains the specific information on support site location, the OS installer will communicate therewith. If driver locator provides only a generic URL, the OS installer application may preferable query system type or service tag information to combine or interpolate with the generic URL to construct a driver locator network address that is unique to target system 12.

Alternately, driver locator 16 might have several values corresponding to OEM, customer, or OS vendor support locations. In this case, the OS installer of target system 12 might a) fetch the software stack based on an ordering policy; b) fetch all software and select the most optimized software or c) present the choices to the user. Furthermore, the OS installer might authenticate with support server 20 before fetching the software for target system 12.

In another alternate embodiment, the OS installer may include a lookup table to store installation resources for multiple vendors (hardware or software providers). For example, OS installer 20 may include the following table with generic driver locator address for the multiple vendors:
Vendor.dell=https://www.dell.com/getdrivers?
Vendor.ABC=https://www.abcvendor.com/getdrivers?
Vendor.XYZ=https://www.xyzvendor.com/getdrivers?

When the OS begins installation, the system type 17 and Unique ID 18 are fetched and merged with the appropriate generic vendor address to construct driver locator 16.

After a driver locator is obtained or constructed, target system 12 may utilize the information contained within driver locator 16 to send a request 60 to operating system installer 20. Request 60 may be referred to as a driver locator request or an SRSL request. Operating installer 20 utilizes the information contained within the driver locator 16 within lookup table 22 in order to identify the drivers necessary for installation within target system 12 as well as to identify location of the necessary drivers within driver databases 40 and/or 50. Operating system installer 20 may then send a request 64 via network 30 and link 68 to driver database 40 or to driver database 50 via link 52. In response, driver databases 40 or 50 may return the necessary drivers to operating system installer 20 either via network 30 (and links 70 and 66) or via link 52. Operating system installer 20 may then provide the necessary drivers to target system 12 for installation within a pre-operating system setting (shown here as arrow 62). Following the installation of the operating system, subsequent operating system updates may preferably be resolved by network based updates.

Now referring to FIG. 2, a method, indicated generally at 100 is shown. The method begins 108 with the factory installation of a process toolkit 110. The factory installation may preferably include burning the system location to the NVRAM the first time to a newly manufactured system. The toolkit preferably includes a set of software tools able to write the system driver locator to the system. The operating system installation media is accessed 114, typically via a stand alone storage media (such as a CD or DVD) or via a networked repository, and a request is made for drivers specific to the target system 116 using the driver locator 16, operating system installer 20 and look up table 22 as discussed above in order to access the repository of driver stacks 118 and fetch OEM drivers 120. The drivers that have been detained are then installed and the operating system installation can then be completed 122 and the process ends 124.

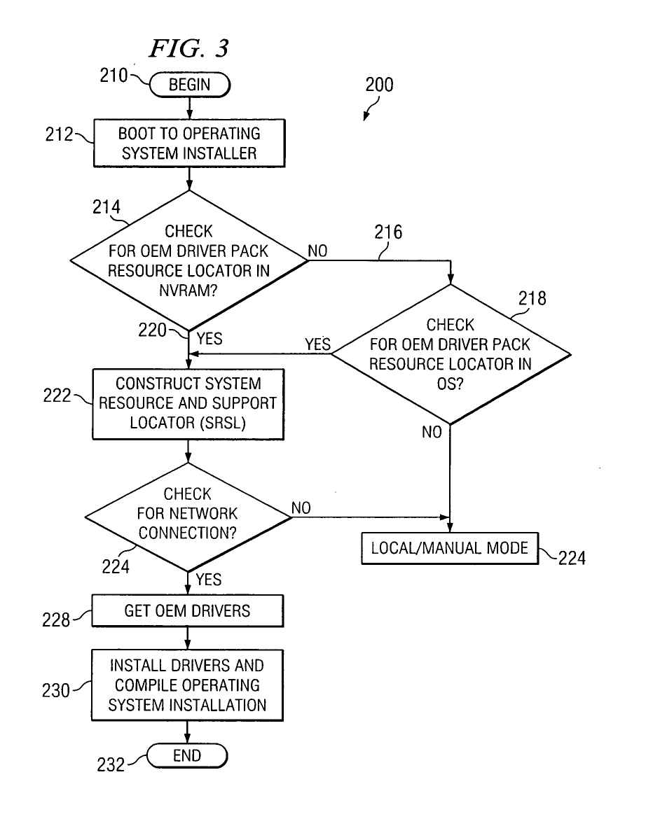

Now referring to FIG. 3, a method, indicated generally at 200 is shown. The method begins 210 with a boot to the operating system installer 212. Next, a determination is made at 214 whether there is an OEM driver stack resource locator (also called a driver locator) within the nonvolatile RAM. If there is no driver path resource locator, the method proceeds to step 218 where there is a check for a OEM driver resource locator in the operating system installer 218. In the event that no driver locator is found within the operating system, a local or manual mode 224 is entered wherein the user is required to manually locate and load drivers necessary for operating system installation.

However, if a driver locator is found within either step 214 or 218 the method proceeds to step 224 in which information within the driver locator is used to construct a driver locator or a system resource and system support locator (SRSL) as described above. The method then checks for a network connection 226. In the event that network connection is unavailable, a local manual operating system installation is required 224. However, if a network connection is found, the necessary drivers may be obtained via network connection 228. The drivers are then installed and the operating system installation may be completed 230, with the method ending 232.

The system and method describe above facilitates automatic detection and injection of the system specific drivers during the native OS installation process. It provides an advantageous way of associating target system 12 with an on-line resource that provides the driver stack for the pre-OS installation environment.

Although the disclosed embodiments have been described in detail, it should be understood that various changes, substitutions and alterations can be made to the embodiments without departing from their spirit and scope.

What is claimed is:

1. An information handling system comprising:
a target system having a nonvolatile memory with a driver locator stored thereon, the target system operable to access the driver locator in a pre-operating system (pre-OS) environment;
an operating system installation resource in communication with the target system;
the driver locator operable to facilitate the connection of the target system with the operating system installation resource in the pre-OS environment; and
the operating system installation resource operable to identify at least one driver needed for the target system based upon the driver locator.

2. The information handling system of claim 1 wherein the driver locator comprises a universal resource locator (URL).

3. The information handling system of claim 2 wherein the URL comprises a system type identifier, the system type identifier corresponding to a system type of the target system.

4. The information handling system of claim 2 wherein the URL comprises a service tag associated with the target system.

5. The information handling system of claim 2 wherein the URL comprises an identifier operable to uniquely identify the target system.

6. The information handling system of claim 2 wherein the URL comprises a selected support site location.

7. The information handling system of claim 1 further comprising a driver database having a plurality of drivers stored thereon, the driver database in communication with the operating system installation resource, the operating system installation resource operable to retrieve drivers from the driver database required by the target system.

8. The information handling system of claim 7, the driver resource in communication with the operating system installation resource via a network.

9. The information handling system of claim 1 further comprising a look-up table stored within the operating system installation resource, the look-up table listing a plurality of driver locators for a plurality of target systems, and corresponding driver data required for each target system.

10. The information handling system of claim 1 wherein the operating system installation resource is operable to retrieve the at least one driver and install the at least one driver on the target system.

11. The information handling system of claim 1 wherein the operating system installation resource is operable to install an operating system on the target system.

12. The information handling system of claim 1 wherein:
the information handling system further comprises a driver locator formation module;
a target system specific unique identifier stored on the NVRAM and a generic URL stored on the NVRAM;
the driver locator formation module operable to combine the target system unique identifier and the generic URL to form the driver locator.

13. A driver locator for use in a pre-operating system (pre-OS) environment comprising:
A network address operable to direct an associated target system to an appropriate operating system installation resource in the pre-OS environment; and
wherein the driver locator comprises a universal resource locator (URL).

14. The driver locator of claim 13 wherein the URL comprises a system type identifier corresponding with the system type of the target system.

15. The driver locator of claim 13 wherein the URL incorporates a service tag associated with the target system.

16. The driver locator of claim 13 wherein the URL comprises an identifier operable to uniquely identify the associated target system.

17. The driver locator of claim 13 wherein the URL comprises a selected support site location.

18. A method for automatically installing drivers in a pre-operating system (pre-OS) environment comprising:
providing a driver locator within a nonvolatile memory of a target system.
accessing the driver locator in a pre-OS environment;
accessing an operating system installation resource using the driver locator; and
determining, by the operating system installation resource, at least one driver based upon the driver locator.

19. The method of claim 18 wherein providing the driver locator comprises providing a universal resource locator (URL).

20. The method of claim 19 wherein the URL comprises an identifier operable to uniquely identify the associated target system.
